(19) United States
(12) Patent Application Publication
(10) Pub. No.: US 2007/0068978 A1
(43) Pub. Date: Mar. 29, 2007

(54) Dual dispensing packaging

(76) Inventors: Matthew Jackson, Chicago, IL (US); Jonathan E. Rathbone, Wolverhampton (GB)

Correspondence Address: BELL, BOYD & LLOYD LLP, P.O. Box 1135, CHICAGO, IL, 60690, US

(21) Appl. No.: 11/234,655

(22) Filed: Sep. 23, 2005

(51) Int. Cl. B67D 3/00; B65D 51/18; B65D 6/28

(52) U.S. Cl. 222/559; 220/4.23; 220/254.9

(57) ABSTRACT

A dual-dispensing product dispenser is provided. In an embodiment, the product dispenser is a confectionery product dispenser. The dispenser comprises one opening having a sliding cover that provides for the dispensing of a small number of pieces of confectionery product, as well as a hingedly attached wall for exposure of the entire inventory of products.

### BACKGROUND

The present invention relates generally to packaging. More particularly, the present invention relates to dispensers for storing and dispensing products, particularly confectionery products.

The packaging for products, particularly confectionery products, is important to the marketing and storage of the product. As such, dispensers come in a variety of sizes, shapes and designs. For example, dispensers can be hand-held containers, with an openable lid for the dispensing of small, individual pieces of confectionery product. Such containers are traditionally useful for dispensing of one individual product, or a small number of individual products, at a time. Alternately, dispensers may be larger, with an openable lid for dispensing many pieces at once.

Traditional dispensers are useful for a number of purposes. In particular, traditional dispensers keep products fresh and free from contaminants. Additionally, where a product consists of a large number of small pieces, traditional containers are useful for maintaining them in a restricted space for easy carrying. Where the containers are larger, they are useful for maintaining a large number of small pieces in a convenient, often decorative, manner.

### SUMMARY

The present invention provides a dual-dispensing apparatus for dispensing products in both small amounts and large amounts. More particularly, the present invention provides a hand-held product dispenser having a body comprising at least two walls. The multiple walls cooperate to define a body, and one wall defines an opening having a cover that is so connected and arranged to allow the product to be dispensed upon movement of the cover. Further, one wall of the dispenser is hingedly attached to the rest of the body. Thus, one can access a limited number of pieces by opening the cover, (e.g. one or more pieces), or may access the entire inventory of pieces by opening the hingedly attached wall.

The products in an embodiment are confectionery products. The teachings of the present invention, however, are not dependent upon the products being any particular type as long as the products can fit within and be dispensed by the hand-held dispenser described herein. The dispenser herein, regardless of what product is being dispensed, is configured to be highly functional as described.

The present invention provides in an embodiment a dual-dispensing product dispenser. Preferably, the dispenser has a body comprised of multiple walls, one of which defines an opening having a slidable cover. In the dispenser, one wall is hingedly attached to the body for accessing the entire inventory of products. The dual dispensers allow distribution of a small amount of product for the single user, as well as access to the whole package for multi-person sharing.

The present invention additionally provides in an embodiment a dual-dispensing confectionery product dispenser.

The present invention additionally provides in an embodiment a securing mechanism for releasably securing the hingedly attached wall to the dispenser.

The present invention additionally provides in an embodiment a dispenser having at least one indentation on the side of the dispenser, with the securing mechanism located therein.

In an embodiment, the securing mechanism is a button and latch mechanism.

In another embodiment, the hingedly-attached wall additionally comprises a lip for easy opening and closing of the wall.

In yet another embodiment, the dispenser allows a user to grip the dispenser and to open and close the slidable closure with the same hand.

It is therefore an advantage of the present invention to provide a hand-held, dual-dispensing product dispenser that is capable of dispensing products.

It is a further advantage of the present invention to provide a hand-held, dual-dispensing confectionery product dispenser that is capable of dispensing confectionery products.

It is a further advantage of the present invention to provide a product dispenser that is compact and easily stored.

Still further, it is an advantage of the present invention to provide a dispenser capable of being held in one hand and of being opened and closed with the same hand.

Yet further, it is an advantage of the present invention to provide a dispenser having one opening for dispensing of a small number of confectionery pieces, and a hingedly-attached wall for accessing the entire inventory of confectionery pieces.

Additional features and advantages are described herein, and will be apparent from, the following Detailed Description and the figures.

### BRIEF DESCRIPTION OF THE FIGURES

FIG. 1 illustrates a perspective view of an embodiment of the product dispenser of the present invention.

FIG. 2 illustrates a side perspective view of the embodiment of the product dispenser of FIG. 1.

### DETAILED DESCRIPTION

The present invention provides a hand-held, dual-dispensing product dispenser. More particularly, in an embodiment the present invention provides a hand-held, dual-dispensing confectionery product dispenser. It will be appreciated that, although in the embodiment illustrated the confectionery products are illustrated as tablets of products, the products to be dispensed can be of any suitable shape and size. Examples of such shapes include pill, block, flat stick, pillow, round, rectangular, triangular, and any combination of same.

The dispenser in the embodiment described below is generally made of a plastic material. In an embodiment, the material is polyethylene or polypropylene. The dispenser is designed to be durable. The present invention expressly includes, however, the dispenser being made of any suitable material.

Additionally, the dispenser in the embodiment described below is compact for easy carrying. More particularly, in an embodiment of the present invention the dispenser is sized to fit neatly into a clothing pocket. In an embodiment the dispenser is less than 25 cm tall and less than 25 cm wide. In another embodiment, the dispenser is less than 20 cm tall and less than 20 cm wide. In yet another embodiment, the dispenser is less than 10 cm tall and less than 10 cm wide. It will be appreciated that the height and width of the dispenser need not be the same dimensions. It will further be appreciated that the dispenser illustrated in the embodiment is expressly not limited to any particular size or shape.

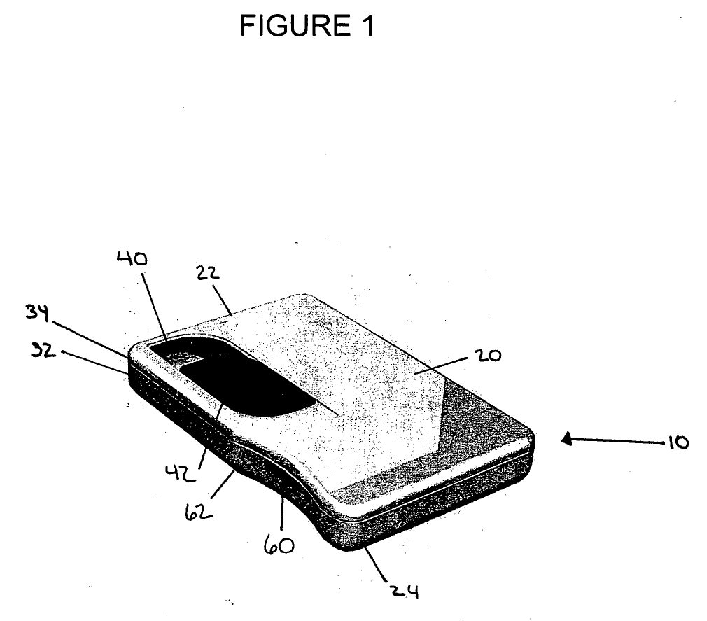

Referring now to the drawings, and in particular to FIG. 1, an embodiment of a dispenser is illustrated at 10. The dispenser generally comprises a body 20. The body 20 is, in the embodiment illustrated in the figures, made generally of two side walls 22, 24. Each side wall comprises siding sections 32, 34 that extend perpendicular from the walls 22, 24. It will be appreciated that the siding sections 32, 34 may be integral with the side walls 22, 24, or may be separate pieces of the dispenser. Alternately, it will also be appreciated that the body 20 may comprise a top wall, a bottom wall, and one or more side walls (not shown).

Defined by one side wall is an opening 40 for dispensing of a small number of confectionery pieces. In the embodiment illustrated in FIG. 1, the opening 40 is shown defined by side wall 22. It will be appreciated that the opening 40 may be located anywhere on the body 20. Further, it will also be appreciated that the opening may be of any suitable size or shape for dispensing of the confectionery pieces contained within the dispenser.

As illustrated in the figures, a cover 42 is removably attached to the opening 40. In an embodiment, as shown in the figures, the cover 42 is slidable. In this embodiment, grooves (not shown) are present within the opening 40. The cover 42 is slidably engaged with the grooves, to vary between an opened and a closed position. It will be appreciated that any manner of cover 42 may be present, including but not limited to a snap-fit cover, a rotating cover, a hinged cover, and variations thereof.

In an embodiment, the cover 42 can be slid by a user while holding the dispenser 10 in the palm of one hand. As the dispenser 10 sits in the user's palm, the user's fingers wrap around the body 20. The user's thumb may preferably apply a force to the cover 42, sufficient to slide the cover 42 from the opening 40 to open the dispenser. Confectionery pieces contained within the dispenser may then be dispensed by pouring the pieces from the dispenser 10.

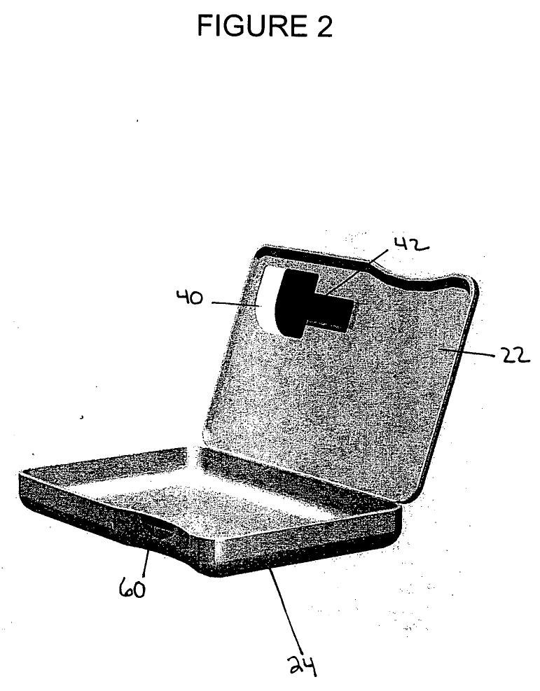

As shown in the embodiment illustrated in FIG. 1, one side wall 22 is hingedly attached to the rest of the body 20. The hingedly attached wall 22 is hinged so as to allow the entire wall to be removed from the body to an opened position, as illustrated in the embodiment of FIG. 2, thereby providing access to all of the contents of the dispenser. This allows a user to remove as many of the pieces of confectionery product as he or she chooses.

As illustrated in the figures, the hingedly attached wall 22 may be secured to the body 20 to prevent opening the dispenser unintentionally. As shown, the hingedly attached wall may be secured by a button and latch mechanism 60. The button and latch mechanism 60 secures the hingedly attached wall 22 when the wall 22 is in a closed position. In this embodiment, the hinge between the walls is spring-loaded so as to be biased in an open position. To release the wall 22 into an opened position, as in FIG. 2, force may be exerted on the button 60. Alternately, where the hinge is not spring-loaded, a force may be exerted on a finger engagement (not shown) to release the wall 22. It will be appreciated that any method of releasably securing the hingedly attached wall 22 in a closed position may be used.

As illustrated in the figures, the button and latch mechanism 60 may be located in an indentation 62 found in the body 20. Where the body 20 is comprised of two walls, 22, 24 as illustrated in the figures, one half of the indentation is present on the siding section 32 of one wall 22, and one half of the indention is present on the siding section 34 of the other wall 24. This indentation 62 prevents the button mechanism from being accidentally triggered, and, by extension, the hingedly attached wall 22 from opening unintentionally. Further, the indentation 62 may provide a way for a user to maintain a tighter grip on the dispenser 10.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A hand-held product dispenser comprising a body comprising at least two walls that define an interior, one wall defining an opening having a sliding cover that is so connected and arranged to allow the product to be dispensed through the opening upon suitable movement of the sliding cover, wherein one wall is hingedly attached to the second wall to allow the walls to separate at one end to reveal the interior.

2. The dispenser of claim 1 wherein the dispenser is a hand-held confectionery product dispenser.

3. The dispenser of claim 2 wherein the cover may be slid between a closed position and a dispensing position in response to a single continuous motion with one hand.

4. The dispenser of claim 1 wherein the opening has internal grooves and the opening cover slidably engages the internal grooves.

5. The dispenser of claim 1 further comprising an indentation in the second wall.

6. The dispenser of claim 5 wherein the hingedly attached wall further comprises a finger engagement that opposes the indentation in the second wall.

7. The dispenser of claim 1 wherein the hingedly attached wall is releasably secured to the second wall by a spring-loaded hinge.

8. A hand-held confectionery product dispenser comprising a body comprising at least two walls that define an interior, one wall defining an opening having a cover that is so connected and arranged to allow the product to be dispensed through the opening upon suitable movement of the cover, wherein one wall is hingedly attached to the second wall to allow the walls to separate at one end to reveal the interior.

9. The dispenser of claim 8 wherein the cover is a sliding cover.

10. The dispenser of claim 9 wherein the opening has internal grooves and the opening cover slidably engages the internal grooves.

11. The dispenser of claim 10 wherein the cover may be slid between a closed position and a dispensing position in response to a single continuous motion with one hand.

12. The dispenser of claim 8 wherein the cover is a rotating cover.

13. The dispenser of claim 8 further comprising an indentation in the second wall.

14. The dispenser of claim 7 wherein the hingedly removable wall further comprises a lip that opposes the indentation.

15. The dispenser of claim 13 wherein the hingedly attached wall is releasably secured to the other wall by a spring-loaded hinge.

16. A hand-held confectionery product dispenser comprising a body comprising at least two walls that define an interior, one wall defining an opening having a sliding cover that is so connected and arranged to allow the product to be dispensed through the opening upon slidable movement of the cover, wherein one wall is hingedly attached to the second wall by a spring-loaded hinge to allow the walls to separate at one end to reveal the interior and further comprising a securing mechanism comprising a button and latch for securing the hingedly attached wall to the second wall.

17. The dispenser of claim 16 wherein the opening has internal grooves and the opening cover slidably engages the internal grooves.

18. The dispenser of claim 17 wherein the cover may be slid between a closed position and a dispensing position in response to a single continuous motion with one hand.

19. The dispenser of claim 16 wherein the hingedly removable wall further comprises a finger engagement that opposes the indentation.

20. A hand-held product dispenser comprising a body comprising at least two walls that define an interior, one wall defining an opening having a cover that is so connected and arranged to allow the product to be dispensed through the opening upon suitable movement of the cover, wherein one wall is hingedly attached to the second wall to allow the walls to separate at one end to reveal the interior.

21. The dispenser of claim 1 wherein the dispenser is a hand-held confectionery product dispenser.

22. The dispenser of claim 1 or 2 wherein the cover is a sliding cover.

23. The dispenser of claim 3 wherein the cover may be slid between a closed position and a dispensing position in response to a single continuous motion with one hand.

24. The dispenser of claim 3 or 4 wherein the opening has internal grooves and the opening cover slidably engages the internal grooves.

25. The dispenser of claim 1 or 2 wherein the cover is a rotating cover.

26. The dispenser of any one of the preceding claims wherein the hingedly attached wall is releasably secured to the second wall by a hinge.

27. The dispenser of claim 7 wherein the hinge which releasably secures the hingedly attached wall to the second wall is spring-loaded.

28. The dispenser according to any one of claims 1 to 6 wherein the hingedly attached wall is releasably secured to the second wall by a button and latch mechanism.

29. The dispenser of any one of claims 1 to 6 wherein the hingedly attached wall further comprises a finger engagement that opposes an indentation in the second wall.

30. The dispenser of any one of claims 1 to 6 wherein the hingedly removable wall further comprises a finger engagement that opposes an indentation in the second wall.

31. The dispenser according to any one of the preceding claims wherein the one wall is hingedly attached to the second wall by a hinge.

32. The dispenser according to claim 12 wherein the hinge which attaches the one wall to the second wall is spring loaded.
